(19) United States
(12) Patent Application Publication
(10) Pub. No.: US 2006/0291049 A1
(43) Pub. Date: Dec. 28, 2006

(54) Screen

(75) Inventors: Andrew K. Juenger, Brush Prairie, OR (US); Gregory J. May, Corvallis, OR (US); Daryl E. Anderson, Corvallis, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company L.P.

(21) Appl. No.: 11/167,033

(22) Filed: Jun. 24, 2005

(51) Int. Cl. G03B 21/56

(52) U.S. Cl. 359/443

(57) ABSTRACT

In embodiments, a screen configured to change states is disclosed.

### BACKGROUND

Many display systems project and reflect images off of a screen. Ambient light that is also reflected off the screen may reduce image contrast. Attempts to reduce the reflection of ambient light may reduce brightness of the reflected images.

### BRIEF DESCRIPTION OF THE DRAWINGS

FIG. 1 schematically illustrates an embodiment of a projection system according to one example embodiment.

FIG. 2 illustrates one example of a synchronization timing sequence that may be employed by the projection system of FIG. 1 according to one example embodiment.

FIG. 3 illustrates another example of a synchronization timing sequence that may be employed by the projection system of FIG. 1 according to one example embodiment.

FIG. 4 illustrates another example of a synchronization timing sequence that may be employed by the projection system of FIG. 1 according to one example embodiment.

FIG. 5A schematically illustrates another embodiment of the projection system of FIG. 1 according to one example embodiment.

FIG. 5B illustrates another embodiment of the projection system of FIG. 1 according to an example embodiment.

FIG. 5C illustrates another embodiment of the projection system of FIG. 1 according to an example embodiment.

FIG. 5D illustrates another embodiment of the projection system of FIG. 1 according to an example embodiment.

FIG. 6 is an example graph illustrating modification of alternating current performed by a current treatment device of the projection system of FIG. 5D according to an example embodiment.

FIG. 7 schematically illustrates another embodiment of the projection system of FIG. 1 according to an example embodiment.

FIG. 8 is a sectional view schematically illustrating an embodiment of a screen of the projection system of FIG. 7 taken along line 8-8 of FIG. 7 according to an example embodiment.

FIG. 9 is a sectional view of light source modulator of the projection system of FIG. 7 taken along line 9-9 according to an example embodiment.

FIG. 10 is a bottom plan view of another ambient light source of the projection system of FIG. 7 taken along line 10-10 according to an example embodiment.

FIG. 11 is a circuit diagram illustrating another embodiment of an ambient light source according to an example embodiment.

FIG. 12 is a schematic illustration of another embodiment of a projector of a projection system of FIG. 1 according to an example embodiment.

FIG. 13 is a front plan view of a color wheel of the projector of FIG. 12 according to an example embodiment.

FIG. 14 is a graph depicting one example synchronization timing sequence that may be used by the projection system of FIG. 1 when including the projector of FIG. 12 according to an example embodiment.

### DETAILED DESCRIPTION OF EXAMPLE EMBODIMENTS

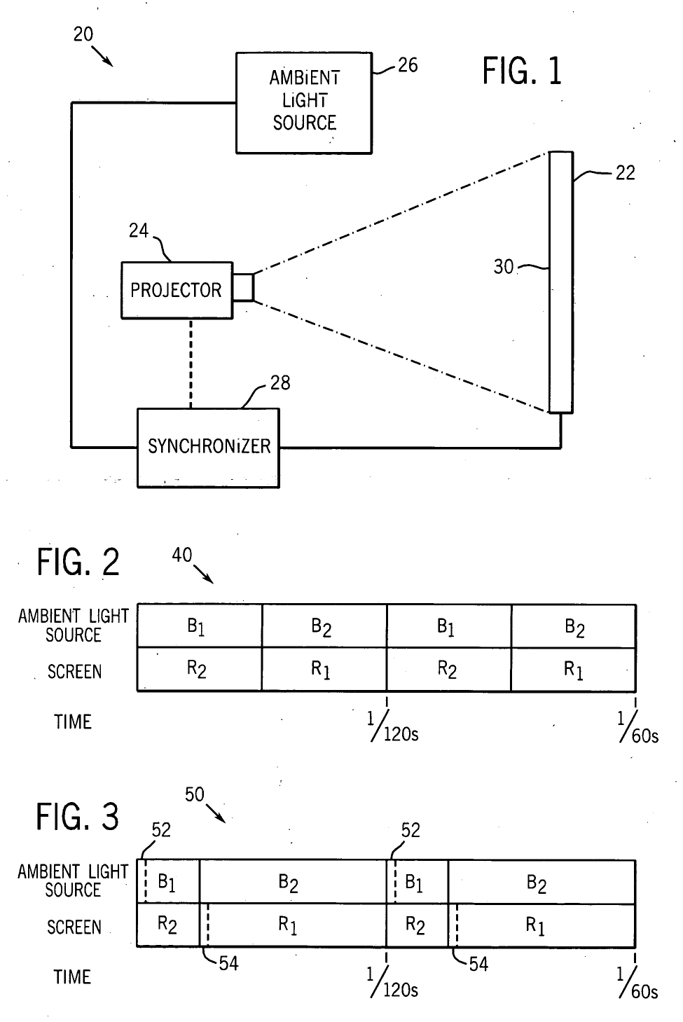

FIG. 1 schematically illustrates display system 20 configured to display images in the presence of ambient light. Display system 20 generally includes screen 22, projector 24, ambient light source 26 and synchronizer 28. Screen 22 comprises a structure having a surface 30 configured to rapidly change or flicker between different reflective states. In one embodiment, surface 30 of screen 22 is configured to flicker between a first reflective state in which substantially all the visual light is reflected and a second reflective state in which a majority of visual light is absorbed. According to one embodiment, surface 30 of screen 22 flickers between a white reflective state and a second black absorbing state in which a substantial percentage of visual light is absorbed. In other embodiments, surface 30 of screen 22 flickers between a first reflective state and a second less reflective state, wherein different levels of electromagnetic radiation, such as infrared light or ultraviolet light are reflected or absorbed.

Projector 24 comprises a device configured to project visual light towards surface 30 of screen 22 such that the incident light is reflected from surface 30 and is viewable by an observer. In one embodiment, projector 24 is configured to project color images at screen 22. In one embodiment, projector 24 may comprise a digital light processing (DLP) projector. In other embodiments, projector 24 may comprise a 35 millimeter projector, an overhead projector or other devices configured to project images of light upon screen 22. In other embodiments, projector 24 may be configured to project other wavelengths of electromagnetic radiation such as infrared light or ultraviolet light and the like.

Ambient light source 26 comprises a source of ambient light for the environment of projector 24 and screen 22. Ambient light source 26 is configured to rapidly change or flicker between different states of brightness in which the environment of screen 22 is lit to different light intensities. In one embodiment, ambient light source 26 flickers between the different brightness levels or states at a frequency greater than or equal to a flicker fusion frequency of observers (i.e., a minimum frequency at which the flickering of light intensity is not noticeable to a human eye). In one embodiment, ambient light source 26 flickers between a lighting state and a dark state. In one embodiment, ambient light source 26 may comprise one or more devices configured to generate and emit pulses of light at differing intensity levels. In one embodiment, ambient light source 26 flickers between a first greater bright state having a peak intensity and a lesser bright state having a low point or level intensity which is less than or equal to 70% of the peak intensity. In one particular embodiment, ambient light source 26 flickers between the bright state having a peak intensity and the lesser bright state having a low point or level intensity which is less than or equal to 50% of the peak intensity. In still other embodiments, the lesser bright state is at a level less than or equal to 25% of the peak intensity of the bright state.

Examples of such ambient light sources include solid state emitters such as light emitting diodes and pulsed gas discharge lamps. In other embodiments, ambient light source 26 may comprise generally continuous light sources such as continuous incandescent lamps that are additionally provided with a mechanical or electrical shutter such that pulses of light are emitted or continuous sources of light with electro optical shutters such as those employing liquid crystals and the like. In still other embodiments, ambient light source 26 may comprise a window having a variable translucency such that pulses of light with different intensity are permitted to pass through the window and pulses at a frequency greater than or equal to the flicker fusion frequency of observers. For example, in one embodiment, ambient light source 26 may comprise a window changeable between a first translucency and a second lesser translucency in which light is blocked and wherein actuation of the window between the two states occurs at a frequency greater than or equal to the flicker fusion frequency of observers. In other embodiments, ambient light source 26 may comprise other such devices.

According to one embodiment, ambient light source 26 comprises a single source of ambient light which flickers between different brightness levels or states at a frequency greater than or equal to a flicker fusion frequency of observers. In another embodiment, ambient light source 26 may comprise multiple sources of ambient light which are synchronized and in phase with one another, wherein the multiple sources flicker at a common frequency or multiples of a common frequency greater than or equal to a flicker fusion frequency of an observer. In still another embodiment, ambient light source 26 may comprise multiple sources of ambient light which flicker at the same frequency or frequencies that are multiples of one another, but which are out of phase. For example, in one embodiment, ambient light source 26 may include a first light source flickering at 30 hertz and another ambient light source flickering at 30 hertz but 180 degrees out of phase with the first ambient light source. If coverage is sufficient, it may appear to an observer that the lights are running at 60 hertz in phase on the resulting lit surfaces.

Synchronizer 28 comprises one or more devices configured to synchronize or otherwise appropriately time the flickering of screen 22 and ambient light source 26. In some embodiments, as shown in FIG. 1, synchronizer 28 is also configured to synchronize flickering of projector 24 with that of screen 22 and ambient light source 26 or hide the flicker in the blanking segments of the projected image or color wheel spokes.

Synchronizer 28 synchronizes the flickering of screen 22 and ambient light source 26 such that screen 22 has a greater reflectivity when ambient light source 26 has a lower brightness and such that screen 22 has a lesser reflectivity when ambient light source 26 has a greater brightness. FIG. 2 schematically illustrates one example of a synchronization timing sequence 40 that may be implemented by synchronizer 28. In the timing sequence shown in FIG. 2, ambient light source 26 flickers or modulates between a first greater brightness state B₁ and a second lesser brightness state B₂. Screen 22 flickers or modulates between a first greater reflectivity state R₁ and a second lesser reflectivity state R₂. In one embodiment, the second lesser brightness state B₂ may be the transmission or emission of no visual light. In other embodiments, the second lesser brightness state B₂ may comprise the transmission or emission of some light but at a lower intensity as compared to the first brightness state B₁. In one embodiment, the second lesser reflectivity state R₂ may result in the complete absorption of light impinging on screen 22, such as when screen 22 is black. In other embodiments, the second lesser reflectivity state R₂ may result in the reflection of some light, but less light as compared to the first greater reflectivity state R₁. In one embodiment, the first greater reflectivity state R₁ may result in reflection of substantially all visual light that impinges on screen 22, such as with a white screen. In other embodiments, the first greater reflectivity state R₁ may result in the reflection of some light, but not substantially all light, but more light as compared to the second lower reflectivity state R₂. In other embodiments, the first greater reflectivity state R₁ may result in the reflection of some particular wavelengths of light and the absorption of other particular wavelengths of light.

As shown by FIG. 2, synchronizer 28 flickers or modulates ambient light source 26 and screen 22 such that ambient light source 26 is in the first greater brightness state B₁ while screen 22 is in the second lesser reflectivity state R₂. Synchronizer 28 further flickers or modulates ambient light source 26 and screen 22 such that ambient light source 26 is in the second lesser brightness state B₂ while screen 22 is in the first greater reflectivity state R₁. As a result, when ambient light source is in the second greater brightness state B₁, screen 22 absorbs a greater percentage of such light and when ambient light source 26 is in the second lesser brightness state B₂, screen 22 reflects a greater percentage of light projected by projector 24. Consequently, the ambient lighting level in the environment of screen 22 may be maintained without the image projected onto screen 22 by projector 24 being as washed out as the image would be without the synchronization. In other words, contrast is maintained in the presence of ambient light.

As further shown by the example synchronization timing sequence 40 in FIG. 2, ambient light source 26 is modulated such that ambient light source 26 is in the first greater brightness state B₁ for a time substantially equal to the time ambient light source 26 is in the second lesser brightness state B₂. Likewise, the time screen 22 is in the first greater reflectivity state R₁ is substantially equal to the time screen 22 is in the second lesser reflectivity state R₂. As shown by FIG. 2, both ambient light source 26 and screen 22 modulate between the brightness states and the reflectivity states at frequencies of 120 cycles per second. Because such modulation is greater than a flicker fusion frequency of the human eye (typically 50 cycles per second or 50 hertz), an unaided human eye is generally not able to detect such flickering. In other words, light emitted or transmitted by the ambient light source appears to be constant while screen 22 also appears to be in a constant state of reflectivity. Although the timing sequence in FIG. 2 illustrates a modulation frequency of 120 hertz for both ambient light source 26 and screen 22, in other embodiments, the modulation frequency may be greater or smaller while being greater than or equal to the flicker fusion frequency of a human eye.

FIG. 3 illustrates another example of a synchronization timing sequence 50 that may be employed by synchronizers 28 (shown in FIG. 1). Timing sequence 50 is similar to timing sequence 40 except that ambient light source 26 is in the second lesser brightness state B₂ a greater percentage of the time as compared to the first greater brightness state B₁. Screen 22 is in the first greater reflectivity state R₁ a greater percentage of time as compared to the second lesser reflectivity state R₂. Because screen 22 is in the first greater reflectivity state R₁ for a greater percentage of time as compared to the second lesser reflectivity state R₂ and because ambient light source 26 is in the second lesser brightness state B₂ a greater percentage of time as compared to the first greater brightness state B₁, more light from projector 24 is reflected by screen 22 and less ambient light is reflected off of screen 22. As a result, the image reflected off of screen 22 and viewed by an observer has enhanced contrast and greater brightness as compared to that resulting from the timing sequence shown in FIG. 2.

According to one embodiment of the timing, sequence shown in FIG. 3, ambient light source 26 is in the second lesser brightness state B₂ and screen 22 is in the first greater reflective state R₁ greater than or equal to 75 percent of the time which provides enhanced contrast while not substantially reducing screen image brightness. In other embodiments, the percentage at which light source 26 is in the second lesser brightness state and in which screen 22 is in the first reflectivity state R₁ may be reduced or enlarged.

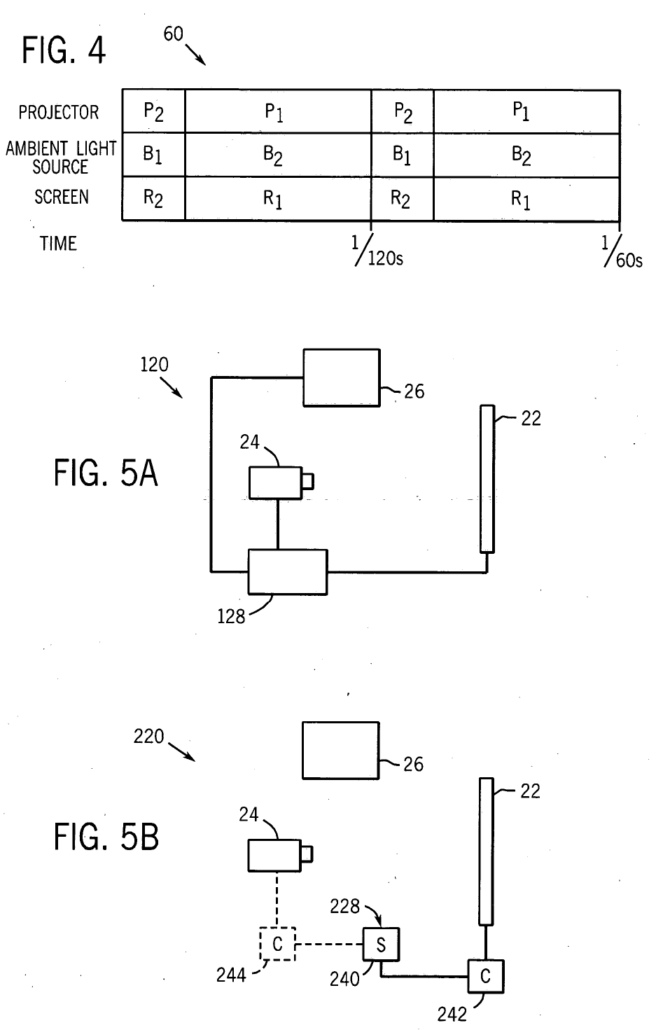

FIG. 3 further illustrates a variation upon synchronization timing sequence 50. In particular embodiments, screen 22 may transition between the first greater reflectivity state R₁ and the second lesser reflectivity state R₂ slower than the rate at which ambient light source 26 is able to transition from the lesser bright state B₂ to the greater bright state B₁. If screen 22 is not in a sufficiently light absorbing state when ambient light source 26 completes its transition to the first greater bright state B₁, an excessive amount of ambient light may be unintentionally reflected off of screen 22, potentially reducing image quality. As shown by FIG. 3, timing sequence 50 may be slightly modified to include guard bands 52 (illustrated by dashed lines succeeding the previous time at which ambient light source 26 was to transition to the greater bright state B₁). Guard bands 52 comprise periods of time that elapse after screen 22 is to complete its transition to the second lesser reflectivity state R₂ before ambient light source begins its transition to the greater bright state B₁. In other words, guard bands 52 provide tolerance to sequence 50 to accommodate potentially slower response times of screen 22. Such guard bands 52 may also be employed in sequence 40 shown in FIG. 2, in sequence 60 shown and described with respect to FIG. 4 or in other synchronization timing sequences between ambient light source 26 and screen 22.

FIG. 3 also illustrates a reverse scenario in which ambient light source 26 transitions between the first greater bright state B₁ and the second lesser bright state B₂ is slower than the rate at which screen 22 is able to transition from a second lesser reflectivity state R₂ to the first greater reflectivity state R₁ . If light from ambient light source 26 is not sufficiently darkened, cut off or terminated when screen 22 completes its transition to the first greater reflectivity state R₁ , an excessive amount of ambient light may be unintentionally reflected off of screen 22, potentially reducing image quality. As further shown by FIG. 3, timing sequence 50 may be slightly modified to additionally include guard bands 54 (illustrated by dashed line succeeding the previous time at which screen 22 was to transition to the first greater reflectivity state R₁). Guard bands 54 comprise periods of time that elapse after ambient light source 26 is to complete its transition to the second lesser bright state B₂ before screen 22 begins its transition to the greater reflectivity state R₁ . Guard bands provide tolerance to sequence 50 to accommodate potentially slower response times for ambient light source 26. Like guard bands 52, guard bands 54 may also be employed in sequence 40 shown in FIG. 2, in sequence 60 shown and described with respect to FIG. 4 or in other synchronization timing sequences between ambient light source 26 and screen 22.

FIG. 4 illustrates one example of a synchronization timing sequence 60 that may be utilized by synchronizer 28 to synchronize operation of projector 24 with ambient light source 26 with screen 22. As shown by FIG. 4, projector 24 flickers or modulates between a first projecting state P₁ in which light projected by projector 24 has a first greater intensity and a second projecting state P₂ in which light projected by projector 24 has a lesser intensity (including a zero intensity, i.e. when no light is projected by projector 24). As further shown by FIG. 4, modulation of projector 24 between the first projection state and the second projection state is synchronized with the modulation of ambient light source 26 between the second brightness state B₂ and the first brightness state B₁ and with the modulation of screen 22 between the first reflectivity state R₁ and the second reflectivity state R₂. Like ambient light source 26 and screen 22, projector 24 modulates between the first and second projection states at a frequency greater than or equal to the flicker fusion frequency of a human eye (nominally about 50 hertz). In the particular example shown, projector flickers at a frequency of approximately 120 hertz and is in the first projection state P₁ while ambient light source 26 is in the second brightness state B₂ and while screen 22 is in the first reflectivity state R₁.

Because projector 24 is modulated in synchronization with screen 22 and ambient light source 26, the light source of projector 24 may be cooled or otherwise be allowed to rest during the second projection state P₂, allowing the light source to be overdriven so as to emit a greater intensity light than would otherwise be achievable during the first projection state P₁ without exceeding or substantially exceeding an average power rating of the light source. As a result, the brightness or intensity of the image projected by projector 24 may be greater without the use of higher intensity and generally more expensive light sources in projector 24. Because projector 24 may rest or be modulated so as to not project light during projection state P₂, energy savings may result. At the same time, the quality of the projected image viewed by an observer does not generally suffer since light that would be projected by projector 24 during projection state P₂ would otherwise be absorbed by screen 22 in the second lesser reflectivity R₂ rather than being substantially reflected.

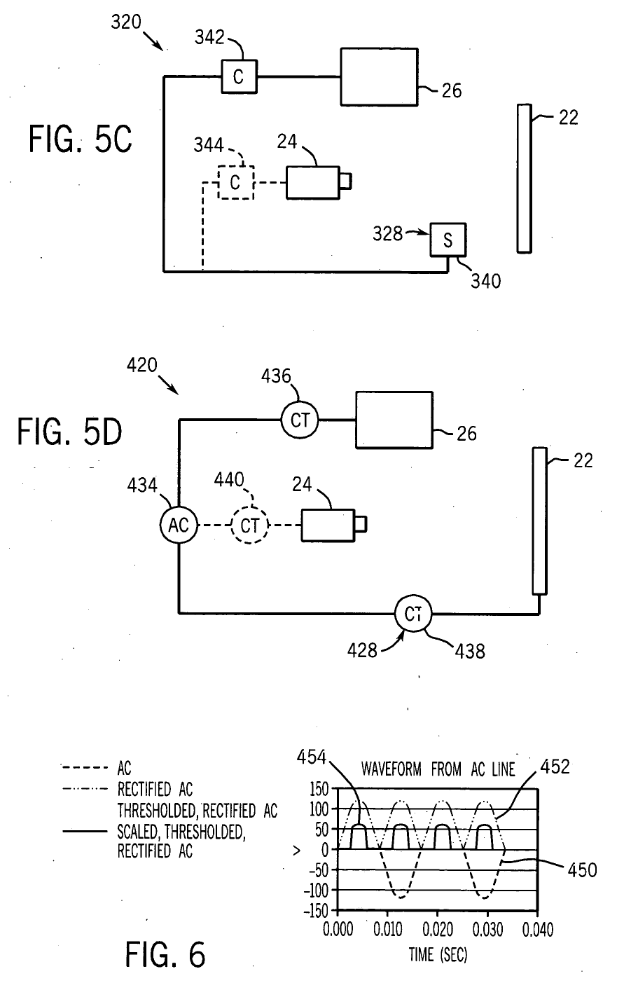

FIG. 5A schematically illustrates projection system 120, a particular embodiment of projection system 20 shown and described with respect to FIGS. 1-4. Projection system 120 is similar to projection system 20 except that projection system 120 has a synchronizer 128 comprising a processing unit configured to generate control signals to both screen 22 and ambient light source 26 so as to synchronize flickering or modulation of screen 22 and ambient light source 26 such as according to the timing sequences described in FIGS. 2 and 3. For purposes of this disclosure, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Synchronizer 128 is not limited to any specific combination of hardware circuitry and software, nor to any particular source for the instructions executed by the processing unit.

The processing unit of synchronizer 128 may communicate with screen 22 and ambient light source 26, as well as potentially with projector 24, by one of various communication modes such as electrical wire or cabling, optical wire or cabling, infrared or other wireless signals. The processing unit comprising synchronizer 128 may be configured to supply power in an intermittent fashion so as to modulate operation of screen 22 and ambient light source 26 or may supply electrical or optical signals directing components associated with screen 22 and ambient light source 26 to modulate such devices. In one embodiment, synchronizer 128 may distribute data or synchronization information over existing electrical wiring such as an alternating current line, wherein screen 22 and ambient light source 26 receives the data or synchronization information which serves as a timing and synchronization signal for screen 22 and ambient light source 26. In such an embodiment, synchronizer 128 may be physically incorporated into either screen 22 or ambient light source 26. In yet another embodiment, synchronizer 128 may be physically incorporated into projector 24 which serves as a master device that sends timing and synchronization signals or data to other slave devices such as screen 22 and ambient light source 26.

According to one example embodiment, the processing unit of synchronizer 128 additionally provides control signals to projector 24 to further synchronize projector 24 with screen 22 and ambient light source 26. For example, in one embodiment, synchronizer 128 may be additionally configured to synchronize screen 22, projector 24 and ambient light source 26 according to the synchronization timing sequence 60 shown in FIG. 4. In other embodiments, synchronizer 128 may synchronize such components in other fashions.

FIG. 5B schematically illustrates projection system 220, another particular embodiment of projection system 20. Projection system 220 is similar to projection system 20 except that projection system 220 includes a synchronizer 228. Those remaining components of projection system 220 which correspond to components of projection system 20 are numbered similarly. In the particular embodiment shown in FIG. 5B, ambient light source 26 is configured to flicker to modulate at a predefined or selected frequency greater than a flicker fusion frequency of a human eye. Synchronizer 228 includes sensor 240 and controller 242. In one embodiment, sensor 240 comprises a light sensor configured to sense light emitted or transmitted by ambient light source 26 so as to detect flickering of ambient light source 26. In one embodiment, sensor 240 comprises a photo sensitive electronic device such as a CdS (Cadmium Sulfide) photoresistor which senses changes in light condition and is off sufficient speed as to adequately sense the light level changes. Other sensor examples include phototransistors and solar cells which have sufficient speed. In other embodiments, sensor 240 may comprise an electrical connection or other sensor directly connected to or associated with ambient light source 26 to detect a characteristic of ambient light source 26 which corresponds to its flickering. Sensor 240 communicates signals to controller 242 based upon the flickering of light from ambient light source 26.

Controller 242 comprises a processing unit configured to generate control signals directing the operation of screen 22 based upon signals received from sensor 240. In response to control signals from controller 242, screen 22 separates or modulates between reflectivity states such as a first greater reflectivity state R₁ and a second less reflectivity state R₂. In one embodiment, controller 242 may be physically coupled to sensor 240 as a distinct unit connected to screen 22. In another embodiment, one or both of controller 242 and sensor 240 may be physically incorporated as part of screen 22.

As indicated in phantom, in other embodiments, sensor 240 may be additionally connected to an additional controller 244. Controller 244 may comprise a processing unit configured to generate control signals directing the operation of projector 24 based upon signals from sensor 240. In such an alternative embodiment, the operation of projector 24 may be synchronized with the operation of screen 22 or the sensed brightness states of ambient light source 26. In other embodiments, controller 244 may be omitted.

FIG. 5C schematically illustrates projection system 320, another embodiment of projection system 20. Projection system 320 is similar to projection system 20 except that projection system 320 includes synchronizer 328. Those remaining components of projection system 320 which substantially correspond to components of system 20 are numbered similarly. In the example shown in FIG. 5C, screen 22 is configured to flicker or modulate between a first greater reflectivity state R₁ and a second lesser reflectivity state R₂ at a predefined or preselected frequency greater than a flicker fusion frequency of the human eye. In one embodiment, screen 22 may include an oscillator and a driver and power supply which facilitate a free running flicker of screen 22. In other embodiments, other electronic circuitry or components may be utilized to facilitate a free running flicker of screen 22 at a frequency greater than a flicker fusion frequency of the human eye.

Synchronizer 328 includes sensor 340 and controller 342. Sensor 340 comprises a sensor configured to detect the flickering or modulation of screen 22. In one embodiment, sensor 340 may comprise an optical sensor. According to one exemplary embodiment, sensor 340 may comprise a phototransistor biased to operate with the speed and light reflectance levels of the screen. This photo transistor may be paired with its own light source such as an LED in a configuration that adequately biases and triggers the sensor 340 by the change in reflectivity of the screen. This light source would reduce light interference from other sources including the out-of-sync ambient light source. Another configuration may include the flickering light source in such a way whereby the combination and state of the light source and screen reflectance could generate an error signal which the synchronizer could use to keep the flickering light in sync with the free running frequency of the screen. According to another embodiment, sensor 340 may comprise an electrical or other sensor directly associated with screen 22 to detect a characteristic of screen 22 which corresponds to its flickering. Sensor 340 communicates signals based upon the sensed or detected flickering to controller 342.

Controller 342 comprises a processing unit configured to generate control signals directing the flickering or modulation of ambient light source 26 based upon signals received from sensor 340. In particular, controller 342 generates control signals directing ambient light source 26 to be in the first greater brightness state B₁ when screen 22 is in the second lesser reflectivity state R₂ and to also cause ambient light source 26 to be in the second lesser brightness state B₂ when screen 22 is in the first greater reflectivity state R₁. In one embodiment, sensor 340 and controller 342 may be incorporated as an independent unit configured to communicate with ambient light source 26. In still another embodiment, sensor 340 and/or controller 342 may alternatively be physically incorporated as part of ambient light source 26. In yet another embodiment, sensor 340 and/or controller 342 may alternatively be physically incorporated as part of a wall switch which controls ambient light source 26.

As shown in phantom, sensor 340 may be configured to additionally communicate with a controller 344. Controller 344 may comprise a processing unit configured to generate control signals directing the operation of projector 24 based upon signals received from sensor 340. In such an embodiment, operation of projector 24 may also be synchronized with or based upon flickering of screen 22 and potentially synchronized with flickering of ambient light source 26.

FIG. 5D schematically illustrates projection system 420, another embodiment of projection system 20. Projection system 420 is similar to projection system 20 except that projection system 420 includes synchronizer 428 in lieu of synchronizer 28. Those remaining components of projection system 420 which correspond to projection system 20 are numbered similarly. Synchronizer 428 synchronizes flickering of screen 22 and ambient light source 26 based upon an alternating current power source 434. In one embodiment, alternating current power source 434 comprises residential alternating current which has a varying polarity in the form of a sine-wave. For example, in the United States, alternating current (AC) power source 434 changes polarity at a frequency of 60 hertz. Synchronizer 428 utilizes the frequency at which the current changes polarity as the basis for the frequency at which screen 22 and ambient light source 26 are modulated or flickered.

According to one example embodiment, synchronizer 428 includes current treatment devices 436 and 438. Current treatment device 436 comprises a device configured to treat or modify the form of electrical current provided by AC power source 434 such that current being supplied to ambient light source 26 is pulsed at a frequency greater than the flicker fusion frequency of a human eye. Accordingly to one embodiment, current treatment device 436 comprises electrical circuitry configured to rectify, reduce the voltage and to trim the rectified alternating current signals to a small duty cycle square wave. According to one embodiment, current treatment device 436 may comprise a dimmer switch or other similar device provided as an independent module or mounted in a wall, floor or other building structure configured to treat or modify the form of electrical current provided by AC power source 434 such that ambient light source 26 is pulsed at a frequency greater than the flicker fusion frequency of a human eye.

FIG. 6 is a graph depicting a 60 hertz residential AC voltage waveform 450, the voltage after it has been rectified (waveform 452) and the voltage waveform after it has been rectified, trimmed and scaled or reduced in voltage per the voltage specifications for ambient light source 26 (waveform 454). The resulting scaled, thresholded (i.e. qualified by comparison of waveform 452 to a threshold level) and rectified waveform 454 pulses at a frequency of 120 hertz. As a result, the scaled, thresholded and rectified waveform 454 may be directly supplied to ambient light source 26 to correspondingly cause ambient light source 26 to pulse, flicker or modulate at a frequency of 120 hertz, a frequency greater or equal to the flicker fusion frequency of the human eye (about 50 hertz).

Current treatment device 438 is similar to current treatment device 436 in that current treatment device 438 modifies the characteristics of the alternating current being supplied by AC power source 434 to a desired form for triggering flickering of screen 22. Current treatment device 438 comprises electrical circuitry configured to sense the phase and modify the alternating current and voltage signals to levels and timing appropriate to drive the screen to different reflectance levels. In one embodiment, like current treatment device 436, current treatment device 438 comprises electrical circuitry configured to rectify, threshold or trim, and scale the alternating current from source 434 for use by screen 22. In some embodiments, current treatment device 438 may not rectify the alternating current from source 434 for use by screen 22 such as when the reflectivity of screen 22 is modulated by applying different voltages to a polymer dispersed liquid crystal.

Current treatment device 438 modifies the voltage from AC power source 434 such that the voltage supplied is in the form of a pulse having a frequency corresponding to but 180 degrees out of phase with the frequency of the voltage being supplied to ambient light source 26 by current treatment device 436 with the opposite duty cycle (1-time of ambient pulse). In the particular example described in which voltage is supplied to ambient light source 26 at a frequency of 120 hertz, current treatment device 438 modifies current from alternating current source 434 such that current is supplied to screen 22 at a frequency of 120 hertz, but 180 degrees out of phase with the current being supplied to ambient light source 26.

In one embodiment, current treatment device 436 is physically incorporated as part of ambient light source 26 while current treatment device 438 is physically incorporated as part of screen 22. In other embodiments, current treatment devices 436 and 438 may comprise independent components or may be combined in a unit independent of screen 22 and ambient light source 26. In another embodiment current treatment device 438 may be included in the ambient light switch for the room. In still other embodiments, synchronizer 428 may alternatively include other timing components in place of current treatment device 436 or current treatment device 438. For example, current treatment device 436 or current treatment device 438 may be replaced with sensor 340 and controller 342 or sensor 240 and controller 242, respectively. One of current treatment devices 436 and 438 may alternatively be replaced with a controller, such as synchronizer 128, configured to modulate one of screen 22 and ambient light source 26 in a frequency corresponding to the frequency at which that of the other screen 22 and ambient light source 26 is modulated.

As further shown in phantom in FIG. 5D, projection system 420 may additionally include current treatment device 440. Current treatment device 440 is similar to current treatment device 438 in that current treatment device 440 comprises electrical circuitry configured to modify the generally sinusoidal form of voltage being supplied from source 434 for use in synchronizing the operation of projector 24 with screen 22 and ambient light source 26. According to one embodiment, current treatment device 440 has electrical circuitry configured to rectify, threshold or trim and scale voltage from source 434 such that a voltage is supplied to projector 24 and pulses for trigger timing at a frequency of the rectified voltage (120 hertz). In one embodiment, current treatment device 440 is configured such that the pulsed voltage being supplied to projector 24 is 180 degrees out of phase with the voltage being supplied to ambient light source 26 as a result of modification by current treatment device 436.

Although projection system 420 has been described as modulating or synchronizing the modulation or flickering of screen 22, ambient light source 26 and potentially projector 24 based upon AC power source 434 comprising U.S. residential 60 hertz alternating current, projector system 420 may alternatively be utilized with other AC power sources 434. For example, projector system 420 may alternatively be utilized with European AC sources which have a frequency of 50 hertz. In such an environment, the rectified waveform would have a frequency of 100 hertz such that the voltage waveform supplied to screen 22, ambient light source 26 and potentially projector 24 would have a frequency of 100 hertz. Other frequencies can be derived but fundamentally the trigger signal can be derived from the phase information of the common AC source.

Overall, projection system 420 facilitates synchronized flickering or modulation of multiple components utilizing an existing timing device provided by AC power source 434. As a result, screen 22, ambient light source 26 and potentially projector 24 may be synchronized without being directly connected to one another and without being connected to a common controller. Rather, current treatment devices 436, 438 and 440 may be incorporated into screen 22, ambient light source 26 and projector 24, respectively, enabling screen 22, ambient light source 26 and projector 24 to be simply plugged into AC power source 434 or electrically connected to AC power source 434. In addition, multiple components of ambient light source 26 may be simply plugged into or electrically connected to AC power source 434. Because current treatment devices 436, 438 and 440 may omit processing units for synchronizing flickering of screen 22, ambient light source 26 and projector 24, projection system 420 may be less expensive and easier to implement.

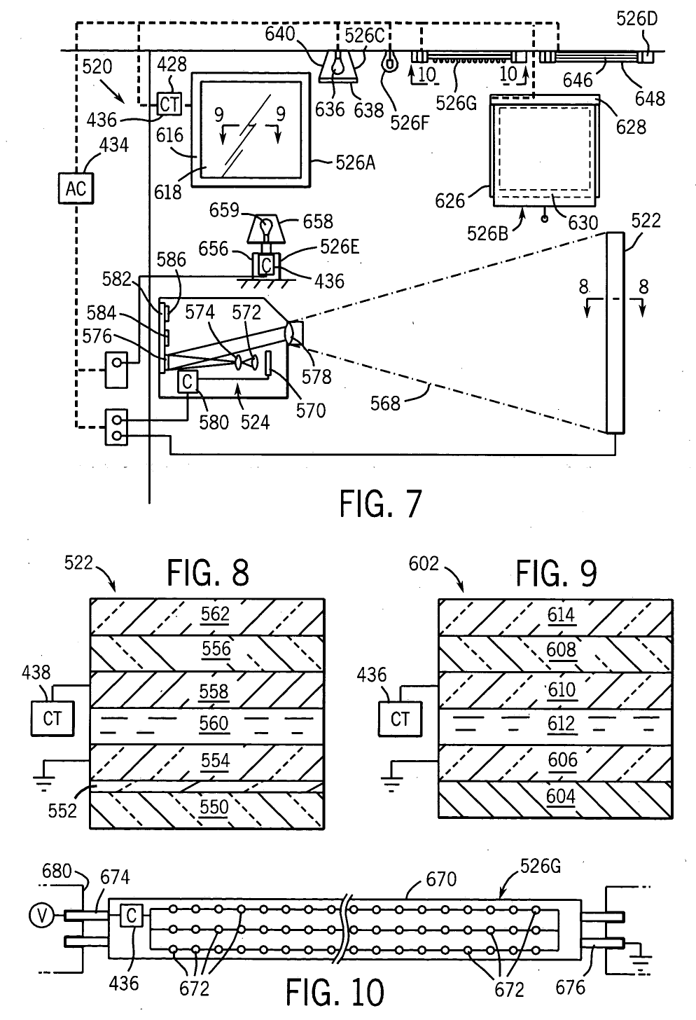

FIG. 7 schematically illustrates projection system 520, one example embodiment of projection system 420. Projection system 520 includes screen 522, projector 524 and ambient light sources 526A, 526B, 526C, 526D, 526E, 526F and 526G, and synchronizer 428. Screen 522 comprises a screen configured to flicker or modulate between a first greater reflective state R₁ and a second lesser reflective state R₂ at a frequency greater than a flicker fusion frequency of a human eye. FIG. 8 is a sectional view schematically illustrating one embodiment of screen 522 in more detail. As shown by FIG. 8, screen 522 includes back substrate 550, reflective layer 552, electrode 554, substrate 556, electrode 558, optical responsive material 560 and coatings 562. Back substrate 550 serves as a support for reflective layer 552. In one embodiment, back substrate 550 comprises dielectric material such as silicon. In other embodiments, back substrate 550 may be formed from other materials such as glass and the like.

Reflective layer 552 comprises a layer of visible light reflecting material supported by back substrate 550. According to one example embodiment, layer 552 is formed from aluminum. In other embodiments, layer 552 may be formed from other materials such as silver or other thin metal coatings.

Electrode 554 comprises a layer of electrically conductive material configured to be electrically charged so as to apply electric field across optical charge responsive material 560. In the particular embodiment illustrated, electrode 554 is formed from transparent or translucent electrically conductive materials that overlie reflective layer 552. In one embodiment, electrode 554 may comprise a conductive material such as indium tin oxide (ITO) or polyethylene dioxythiophene (PEDOT). In other embodiments, electrode 554 may be formed from other transparent electrically conductive materials.

Front substrate 556 comprises a support structure for electrode 558. Front substrate 556 is formed from an optically transparent and clear dielectric material. In one embodiment, front substrate 556 may be formed from an optically clear and flexible dielectric material such as polyethylene terephalate (PET). In other embodiments, front substrate 556 may be formed from other transparent dielectric materials that may be inflexible such as glass.

Electrode 558 comprises a layer of transparent or translucent electrically conductive material formed upon substrate 556. Electrode 558 is configured to be charged so as to cooperate with electrode 554 to create an electric field across optical charge responsive material 560. In one embodiment, electrode 558 comprises a transparent conductor such as ITO or PEDOT. In other embodiments, other transparent conductive materials may be used. In the particular embodiment shown in which projection system 520 utilizes synchronizer 428, electrode 558 is electrically connected to current treatment device 438 while electrode 554 is electrically connected to ground. In other embodiments, this arrangement may be reversed. In still other embodiments, electrodes 554 and 558 may be charged to distinct voltages by other devices such as synchronizer 28 or controller 242.

Optical charge responsive material 560 comprises a layer of material configured to change its transparency and reflectivity in response to changes in an applied voltage or charge. In one embodiment, material 560 may change from a transparent clear state, allowing light to pass through material 560 and to be reflected by reflective layer 552 to a generally opaque state in which light is absorbed by material 560. According to one example embodiment, material 560 may comprise a dichroic dye doped polymer dispersed liquid crystal (PDLC) material in which pockets of liquid crystal material are dispersed throughout a transparent polymer layer. In other embodiments, material 560 may comprise other materials such as electrochromic material, such as tungsten oxide, or photochromic or electrophoretic material.

Coatings 562 comprises one or more layers deposited or otherwise formed upon substrate 556 opposite to electrode 558. Coatings 562 may comprise a front plane diffuser and may include an anti-reflection layer such as anti-glare surface treatment, an ambient rejection layer, such as a plurality of optical band pass, or a series of micro lenses and/or partial diffuse layers. In other embodiments, coating layer 562 may be omitted. In other embodiments, screen 22 may comprise other structures configured to flicker or modulate between two or more reflective states.

As shown by FIG. 7, projector 524 comprises a device configured to sequentially project a series of colors (light of different wavelengths) towards screen 22 so as to create an image upon screen 22. In the particular example illustrated, projector 524 comprises a digital light processing (DLP) projector which generally includes light source 570, optics 572, optics 574, digital micro mirror device (DMD) 576 and projection lens 578. Light source 570 comprises a multi-colored (or broad spectrum) solid state lamp configured to sequentially emit different colored light. In one embodiment, light source 570 comprises a multi-colored light emitting diode lamp including multiple differently colored light emitting diodes. In one embodiment, light source 570 includes diodes having red, green and blue colors. In another embodiment, light source 570 may include light emitting diodes having red, green and blue colored light emitting diodes plus possibly white light emitting diodes. The differently colored light emitting diodes are sequentially actuated in response to control signals or applied voltages from controller 580 which comprises a processing unit and a power switching device to selectively direct power to each of the sets of differently colored light emitting diodes of light source 570.

Optics 572 are generally positioned between light source 570 so as to condense light from light source 570 towards optics 574. In one embodiment, optics 572 may include a light pipe or integrating rod. Optics 574 comprises one or more lenses or mirrors configured to focus and direct light towards DMD 576. In one embodiment, optics 574 may comprise lenses which focus and direct the light. In another embodiment, optics 574 may additionally include mirrors which re-direct light onto DMD 576.

In one embodiment, DMD 576 comprises a semiconductor chip covered with a multitude of miniscule reflectors or mirrors which may be selectively tilted between “on” positions in which light is redirected towards lens 578 and “off” position in which light is not directed towards lens 578. The mirrors are switched “on” and “off” at a high frequency so as to emit a grayscale image. In particular, a mirror that is switched on more frequently reflects a light gray pixel of light while the mirror that is switched off more frequently reflects a darker gray pixel of light. In this context, “grayscale”, “light gray pixel”, and “darker gray pixel” refers to the intensity of the luminance component of the light and does not limit the hue and chrominance components of the light. The “on” and “off” states of each mirror are coordinated with colored light from light source 70 to project a desired hue of colored light towards lens 578. The human eye blends rapidly alternating flashes to see the intended hue of a particular pixel in the image being created. In the particular example shown, DMD 576 is provided as part of a DLP board 582 which further supports a processor 584 and associated memory 586. Processor 584 and memory 586 are configured to selectively actuate the mirrors of DMD 576. In other embodiments, processor 584 and memory 586 may alternatively be provided by or associated with controller 580.

Because ambient light sources 526 are flickering and are synchronized with screen 522 so as to be in a lesser brightness state B₂ while screen 522 is in a greater reflectivity state R₁, the color contrast and intensity of light projected by projector 524 is not reduced or washed out by light from ambient light sources 526. As a result, less expensive or lower intensity light sources, such as light source 570 may be employed in projector 524. Because projector 524 facilitates the use of generally lower intensity light emitting diodes for light source 570, the cost and complexity of projector 524 is reduced.

Ambient light sources 526 either emit visual light or transmit visual light to the environment of screen 522 and projector 524. Ambient light sources 526 flicker between distinct brightness states at a frequency greater than or equal to a flicker fusion frequency of a human eye. Ambient light sources 526A-526E modulate between distinct light transmissive states at a frequency greater than or equal to a flicker fusion frequency of a human eye. In the particular embodiment illustrated, each of ambient light sources 526A-526E includes a light transmission modulator 602 shown in FIG. 9. Light transmission modulator 602 comprises a series of layers configured to exhibit varied light transmission properties based upon an applied voltage or charge. Light transmission modulator 602 includes substrate 604, electrode 606, substrate 608, electrode 610, optical charge responsive material 612 and coating layer 614.

Ambient light sources 526A and 526B selectively permit the transmission of visual light from another source, such as the sun. Ambient light source 526A generally comprises a window including a frame 616 and a pane 618 and light transmission modulator 602. Frame 616 supports pane 618 and may include electrical components of ambient light source 526A. In one embodiment in which projection system 520 includes synchronizer 428, frame 600 houses current treatment device 436.

In FIG. 9, substrate 604 comprises one or more layers of transparent materials serving as a foundation of support for electrode 606. In one embodiment, substrate 604 may comprise glass. In another embodiment, substrate 604 may comprise other transparent flexible or inflexible dielectric materials such as plexiglass or polyethylene terephalate (PET).

Electrode 606 comprises one or more layers of transparent electrically conductive material. In one embodiment, electrode 606 is formed from indium tin oxide. In other embodiments, electrode 606 may be formed from other transparent electrically conductive materials such as single wall carbon nano tubes such as available from Ikos Systems and thin layers of metals such as gold or silver. Substrate 608 comprises one or more layers of transparent material serving as a foundation or support for electrode 610. In one embodiment, substrate 608 may comprise glass. In other embodiments, substrate 608 may comprise other transparent flexible or inflexible dielectric materials such as plexiglass or PET.

Electrode 610 comprises one or more layers of transparent electrically conductive material. In one embodiment, electrode 610 is formed from indium tin oxide. In other embodiments, electrode 610 may be formed from other transparent electrically conductive materials.

Optical change responsive material 612 comprises a layer of material configured to change its transparency and/or light absorption in response to changes in an applied voltage or charge. In one embodiment, material 612 may change from a transparent clear state, allowing light to pass through material 612 to a reflective or absorbing state in which light is absorbed by material 612. According to one example embodiment, material 612 may comprise a dichroic dye doped polymer dispersed liquid crystal (PDLC) material in which pockets of liquid crystal material are dispersed throughout a transparent polymer layer. In other embodiments, material 612 may comprise other materials such as electro chromic material, such as tungsten oxide or photochromic or electrophoretic material. Optical charge responsive material 612 is generally located between electrodes 606 and 610. In response to a modulating charge applied to at least one of electrodes 606 and 610, material 612 also modulates between a first greater light transmissive state and a second lesser light transmissive state. Coating layer 614 comprises one or more substantially transparent layers deposited or otherwise formed upon substrate 608 opposite to electrode 610. Coating layer 614 may comprise a front plane diffuser and may include an anti-reflection layer such as an anti-glare surface treatment. In other embodiments, coating layer 614 may be omitted.

Pane 618 of FIG. 7 comprises one or more panes or panels of transparent material, such as glass, supported by frame 600.

Light transmission modulator 602 extends across pane 602 so as to selectively block the transmission of light or to allow transmission of light through pane 618. In one embodiment, light transmission modulator 602 (shown in FIG. 9) may be laminated, bonded or otherwise secured to and across pane 618. In another embodiment, light transmission modulator 602 may be supported by frame 616 so as to extend across and generally parallel to pane 618. In yet another embodiment, one or more portions of pane 618 may be omitted where light transmission modulator 602 has sufficient strength and rigidity. For example, in one embodiment, pane 618 may be omitted where one or both of substrates 604 and 608 is formed from a rigid dielectric material such as glass.

Ambient light source 526B includes window 626 and window shade 628. Window 626 comprises an opening through which light may pass to the environment of screen 522. In one embodiment, window 526 may include one or more transparent panes through which light may pass. In another embodiment, window 626 may include openings or at least partially transparent screens through which light may pass.

Window shade 628 comprises a device having a selectively transparent or selectively opaque window overlying portion 630. Portion 630 includes light transmission modulator 602 shown and described with respect to FIG. 9. In response to electric fields applied across optical charge responsive material 612, portion 630 modulates or flickers between a first visual light transmissive state and a second distinct transmissive state. In one embodiment, portion 630 flickers or modulates between a substantially opaque state in which portion 630 blocks light passing through window 626 and a substantially transparent state in which light passes through window 626 and through portion 630.

In the embodiment shown in FIG. 7, portion 630 and light transmission modulator 602 (shown in FIG. 9) are sufficiently flexible so as to permit portion 630 to be rolled up into a roll about an axis. In such an embodiment, substrates 604 and 608 may be formed from a flexible polymeric material such as PET or vinyl, electrodes 606 and 610 may be formed from a flexible transparent electrically conductive material such as indium tin oxide and optical charge responsive material 612 may be formed from and may comprise a material such as PDLC material. In one particular embodiment, substrates 604 and 608 may serve as opposite sides of portion 630. In other embodiments, substrate 604 or substrate 608 may be coupled to another transparent flexible material associated with portion 630.

Because portion 630 is flexible such that portion 630 may be rolled into a roll, shade 628 may comprise a pull-down shade which may be rolled up so as to extend across window 626 by different extents or so as to be completely retracted with respect to window 626. In other embodiments, shade 628 may comprise other configurations of shades or blinds having a portion 630 that overlies window 626 and includes light transmission modulator 602. For example, shade 628 may alternatively comprise a vertical blind, an accordion-style blind and the like.

Ambient light source 526C emits light at a frequency greater than a flicker fusion frequency of a human eye. Ambient light source 526C includes continuous light source 636 and cover 638. Continuous light source 636 comprises a source of continuous light such as an incandescent or fluorescent bulb. Light source 636 may be recessed within a wall or ceiling or may be partially enclosed by a housing 640. Cover 638 extends between light source 636 and screen 522. Cover 638 is formed from one or more layers of transparent material and additionally includes light transmission modulator 602 (shown in FIG. 9) extending substantially across cover 638. In one embodiment, cover 638 may be substantially provided by light transmission modulator 602. In operation, light transmission modulator 602 flickers or modulates between a first visual light transmissive state and a second distinct light transmissive state at a frequency greater than the flicker fusion frequency of a human eye.

Ambient light source 526D emits visual light at a frequency greater than or equal to the flicker fusion frequency of a human eye. Ambient light source 526D includes continuous light source 646 and cover 648. Light source 646 generally comprises an elongate tube configured to continuously emit light. In one embodiment, light source 646 comprises a gas discharge light cell such as a fluorescent lighting tube.

Cover 648 comprises an elongate cylinder, tube or sleeve extending and positioned about lighting source 646. Cover 648 includes light transmission modulator 602 extending between source 646 and screen 522. In one embodiment, light transmission modulator 602 extends along a lower portion of cover 648 opposite a lower portion, such as the lower half, of light source 646.

In other embodiments, light transmission modulator 602 substantially extends about cover 648 and around or about light source 646. In one particular embodiment, cover 648 is removably positioned about light source 646, allowing light source 646 to be replaced without discarding cover 648. In another embodiment, cover 648 may be mounted to light source 646 or light transmission modulator 602 may be coated upon the tube of light source 646.

In another embodiment, cover 648 may be omitted where light source 646 comprises a gas discharge light cell, such as a fluorescent lighting tube, including short persistence phosphors. In such an embodiment, the tube includes axially extending pins configured to start charge and ground the gas discharge light cell or tube. Charging of the gas occurs at a frequency greater than a flicker fusion frequency of an observer. For example, in one embodiment, the charging of the gas cell may be at a frequency equal to an alternating current supplied to the cell such as 50 hertz (Europe) or 60 hertz (United States). In one embodiment, the short persistence phosphors absorb light from the excited gas and emit visual light.

The short persistence phosphors are also configured to flicker between bright states (such as an emitting state and a dark state) at a frequency greater than or equal to a flicker fusion frequency of an observer. In such an embodiment, the short persistence phosphors may have a duty cycle of less than 25% and nominally less than or equal to 10% with a decay time of less than or equal to 1% of the duty cycle. In one embodiment, the short persistence phosphors may comprise silver-activated zinc sulfide such as a P4 phosphor commercially available from Torr Scientific. In other embodiments, ambient light source 526D may comprise a gas discharge light cell including other short persistence phosphors having other duty cycles and decay times.

Ambient light source 526E is configured to emit visual light at a frequency greater than or equal to the flicker fusion frequency of a human eye. Ambient light source 526E generally comprises a lamp 656 and a lamp shade 658. Lamp 656 comprises a source of continuous light. For example, in one embodiment, lamp 656 may include an incandescent light bulb or a fluorescent bulb.

Lamp shade 658 is supported about the light bulb of lamp 656 and includes light transmission modulator 602 shown in FIG. 9. Light transmission modulator 602 extends between bulb 659 and screen 522. In one embodiment, light transmission modulator 602 extends along a portion of shade 658. In another embodiment, light transmission modulator 602 extends along a substantial entirety of shade 658 around bulb 659. In response to distinct electrical fields applied across optical charge responsive material 612, light transmission modulator 602 modulates or flickers between a first light transmissive state and a second distinct light transmissive state. As a result, shade 658 selectively attenuates light from bulb 659.

Ambient light source 526F comprises a device configured to emit visual light at a frequency greater than or equal to a flicker fusion frequency of a human eye. Ambient light source 526F may comprise a solid state light emitting device such as a light emitting diode light bulb having an arrangement of light emitting diodes and a threaded base configured to charge and ground the light emitting diodes. Examples of such light emitting diode bulbs are those commercially available from Enlux Lighting of Mesa, Ariz., and those available from Ledtronics, Inc., of Torrance, Calif. However, unlike such light emitting diode bulbs as those commercially available, ambient light source 526F is configured to flicker or modulate at a frequency greater than the flicker fusion frequency of a human eye. As a result, ambient light source 526 may be synchronized with flickering of screen 522 to enhance contrast in the presence of ambient light. According to one embodiment, ambient light source 526 is configured such that the light emitting diodes flicker at a frequency greater than or equal to a flicker fusion frequency of an observer and with the work duty cycle of less than 80%. In such an embodiment, projector 524 correspondingly projects light at least 20% of the time and screen 22 correspondingly is in the greater reflective state at least 20% of the time. In one embodiment, such light emitting diodes flicker at a frequency greater than or equal to the flicker fusion frequency of an observer and with a work duty cycle less than or equal to 50% and nominally less than or equal to about 25%. In one embodiment, the light emitting diodes of ambient light source 526 flicker between a first bright state having a peak intensity and a lesser bright state having a lesser intensity less than 80% of the peak intensity and nominally less than 50% of the peak intensity.

Ambient light source 526G comprises a device configured to emit visual light at a frequency greater than or equal to the flicker fusion frequency of a human eye. Ambient light source 526G is shown in detail in FIG. 10. As shown in FIG. 10, ambient light source 526G comprises an elongate support structure 670, an elongate series or array of light emitting diodes 672 and axially extending conducting pins 674, 676. Support 670 supports light emitting diodes 672 which are electrically connected to conductive pins 674 and 676. Pin 674 is configured to be connected to a voltage source while pin 676 is configured to be electrically connected to ground. Support 670 and pins 674, 676 are specifically configured to mount within an existing socket 680 for a fluorescent tube or lamp. As a result, the fluorescent tube or lamp may be replaced with ambient light source 526G. However, unlike fluorescent lamps, ambient light source 526G is configured to flicker or modulate at a frequency greater than the flicker fusion frequency of a human eye. As a result, ambient light source 526 may be synchronized with flickering of screen 522 to enhance contrast in the presence of ambient light.

In the particular embodiment shown in FIG. 7, synchronizer 428 includes multiple current treatment devices which modify current from alternating current power source 434 so as to modulate or flicker screen 522 and each of ambient light sources 526. In the particular example shown, screen 522 includes circuit treatment device 438 (shown in FIG. 5D). Each of ambient light sources 526 includes a current treatment device 436 (shown and described with respect to FIG. 5D). In those ambient light sources 526 which include light transmission modulator 602, one of conductors 606, 608 is electrically connected to ground while the other of electrodes or conductors 606, 608 is electrically connected to current treatment device 436. As a result, the electric field between electrode 606 and 608 modulates such that the light reflectivity of light transmission modulator 602 also modulates. In other embodiments, projection system 520 may utilize other light synchronizers such as described with respect to FIGS. 5A-5C.

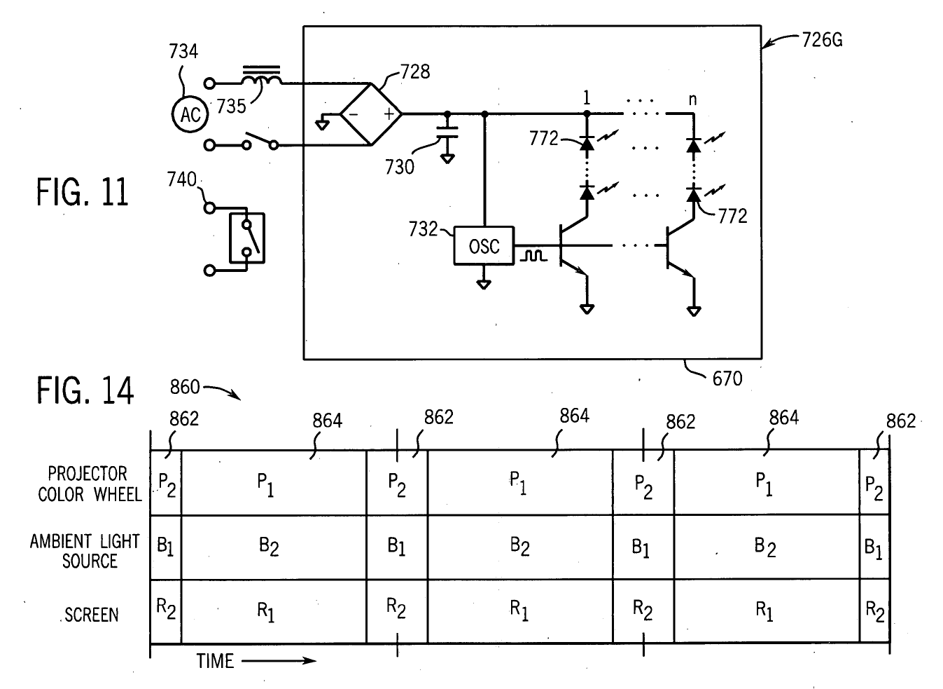

FIG. 11 schematically illustrates ambient light source 726G, another embodiment of ambient light source 526G. Ambient light source 726G is similar to ambient light source 526G except that ambient light source 726G incorporates rectifier 728, capacitor 730 and oscillator 732. Rectifier 728 and capacitor 730 cooperate to convert the alternating current received from current source 734 which includes a ballast 735 to provide a current limit circuit for source 734. In one embodiment, ambient light source 726G may be connected in place of a fluorescent light tube. As a result, as shown by FIG. 11, starter 740 of the circuit supplied for use with a fluorescent tube is out of the circuit and is idle.

Oscillator 732 oscillates the DC voltage to a desired frequency for the voltage charges supplied to each of light emitting diodes 772. In the particular example shown, oscillator 732 is configured to oscillate the DC voltage at a frequency of 72 hertz and at a 10 percent duty cycle in which light emitting diodes 772 are pulsed so as to emit light at 10 percent of the time and are off the remaining 90 percent of the time. Because light emitting diodes 772 are in an on state 10 percent of the time, the image reflected from screen 522 (shown in FIG. 6) has greater contrast as compared to light emitting diodes 772 having a larger duty cycle. Because light emitting diodes 772 of ambient light source 726G are flickered or modulated at a frequency of 72 hertz, which is greater than or equal to a flicker fusion frequency of the human eye (generally about 50 hertz), an unaided observer generally cannot discern the flickering of ambient light source 726G. At the same time, because light emitting diodes 772 are modulated or flickered at a frequency of 72 hertz versus a higher frequency, screen 522 may also be modulated at a lower frequency such as 72 hertz between reflectivity states. As a result, ambient light 726G permits slower, less responsive screens 522 to be synchronized with ambient light source 726G.

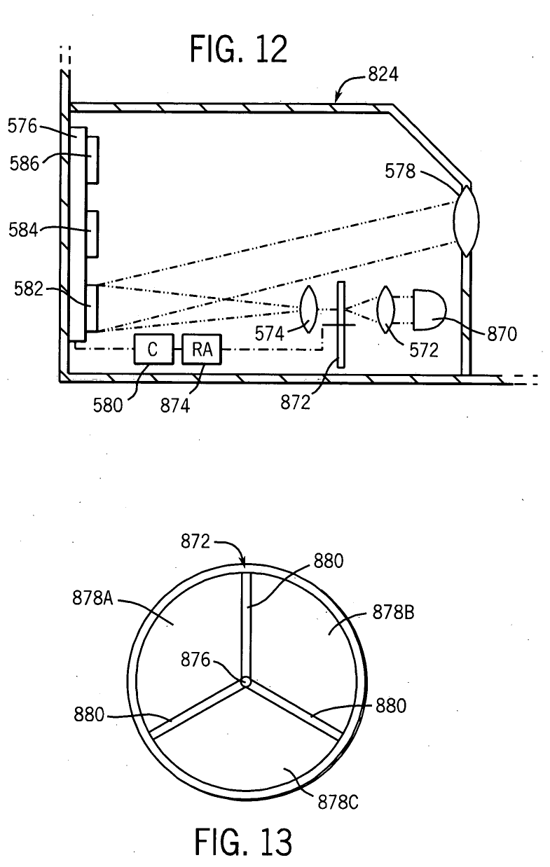

FIG. 12 schematically illustrates projector 824, another embodiment of projector 524 shown in FIG. 7. Projector 824 is similar to projector 524 except that projector 824 includes light source 870 in lieu of light source 570 and additionally includes color wheel 872 and rotary actuator 874. Those remaining components of projector 824 which corresponds to projector 524 are numbered similarly. Light source 870 comprises a source of light such as an ultra high pressure (UHP) arc lamp and reflector configured to emit light towards optics 572. In other embodiments, other sources of light may be used such as metal halide lamps and the like. Color wheel 872 comprises an optical component configured to sequentially image color. As shown by FIG. 13, color wheel 872 generally comprises a disk or other member having a plurality of distinct filter segments positioned about a rotational axis 876 of wheel 872 and arranged such that light from optics 572 passes through such filter segments 878A, 878B and 878C (collectively referred to as segments 878) towards DMD 576. In one particular embodiment, color wheel 872 may include circumferentially arranged portions including red, green and blue filters. In still other embodiments, color wheel 872 may additionally include a clear segment. In still another embodiment, color wheel 872 may include a first red segment, a first green segment, a first blue segment, a second red segment, a second green segment and a second blue segment. Each of segments 878 is separated by a spoke 880.

Spokes 880 constitute dead zones or seams between adjacent color filters or segments 878. During rotation of color wheel 872, there are rotational positions of color wheel 872 for which light simultaneously illuminates or passes through adjacent color segments 878. Since such light simultaneously passing through adjacent color filters or segments 878 comprises a mixture of primary colors, this light is not projected from projector 824. As a result, such seams constitute dead zones or virtual spokes in which light is not projected from projector 824. In some embodiments, spokes 880 may comprise physical spots that block light transmission. Such dead zones are illustrated as spoke times 862 in FIG. 14.

Rotary actuator 874 comprises a device configured to rotatably drive color wheel 872 such that light from light source 870 sequentially passes through filter segments 878. In one embodiment, rotary actuator comprises a motor and an appropriate transmission for rotating color wheel 872 at a desired speed. In other embodiments, rotary actuator 874 may comprise other devices configured to rotatably drive color wheel 872 in response to control signals from controller 580.

FIG. 14 illustrates one example synchronization timing sequence 860 for rotation of color wheel 872 of projector 824, ambient light source 26 (shown in FIG. 1) and screen 22 (shown in FIG. 1). As shown by FIG. 14, during rotation of color wheel 872 by rotary actuator 874, little or no light (lesser projection state P₂) is projected by projector 824 during spoke times 862. In one embodiment, controller 580 of projector 824 generates control signals coordinating or synchronizing the flickering or modulation of ambient light source 26 and screen 22 such that during some of such spoke times 862, ambient light source 26 is in the first greater brightness state B₁ and such that screen 22 is in the second lesser reflectivity state R₂. During the transmission of light from light source 870 through segments 878 towards screen 22 when projection 824 is in a greater projection state P₂ (as indicated by time periods 864), controller 580 generates control signals synchronizing the modulation or flickering of ambient light source 26 and screen 22 such that ambient light source 26 is in the second lesser brightness state B₂ and such that screen 22 is in the first greater reflectivity state R₁. In one embodiment, ambient light source 26 does not emit light or substantially attenuates transmission of light during the second lesser brightness state B₂. In one embodiment, screen 22 is substantially white when screen 22 is in the first greater reflectivity state and is substantially black when screen 22 is in the second lesser reflectivity state R₂. In other embodiments, brightness state B₂ and reflectivity states R₁ and R₂ may have other characteristics.

With the particular synchronization timing sequence 860 shown in FIG. 14, ambient light source 26 is in the first greater brightness state B₁ and screen 22 is in the second reflectivity state in which more light is absorbed while projector 824 is not projecting light. As a result, the ambient light provided by ambient light source 26 does not wash out colors from projector 824 and the intensity of the image projected by projector 824 remains as originally designed since screen 22 is in the lesser reflective state R₂ while projector 824 is not projecting light. At the same time, when projector 824 is projecting light through one of segments 878, screen 22 is in the greater reflectivity state R₁ and ambient light source 26 is in the lesser brightness state B₂ for improved contrast. In other embodiments, synchronization timing sequence 860 may be modified such that screen 22 has the lower reflectivity R₂ while projector 824 continues to project light through segments 878 and is not at a spoke position.

Overall, projection systems 20, 120, 220, 320, 420 and 520 may maintain the contrast of a projected image that is reflected from a screen while providing an observer of the image with ambient lighting. By actuating screen 22, 522 to a lower reflectivity state while ambient light source 26, 526 is in a greater brightness state, the observer is provided with ambient lighting and screen 22, 522 absorbs such ambient lighting. By actuating screen 522 to a greater reflectivity state while ambient source 526 is in a lesser brightness state, screen 522 is able to reflect an image projected by a projector, such as projector 24, 524 or 824, with reduced washing out of the image by ambient lighting. Because such modulation or flickering of screens 22, 522 as well as ambient light sources 26, 526 is at a frequency greater than the flicker fusion frequency of a human eye, an unaided human observer is generally unable to notice such modulation or flickering. Synchronizers 128, 228, 328 and 428 provide various methods or techniques by which the modulation of screen 22, 522 and ambient light sources 26, 526 may be synchronized with one another. In particular embodiments, projector 24 may also be synchronized with screens 22, 522 and ambient light sources 26, 526. Ambient light sources 526A-526G provide various low cost and effective devices and techniques for modulating ambient light at a frequency greater than the flicker fusion frequency of a human eye, permitting such light sources to be used as part of projection systems 20, 120, 220, 320, 420 and 520.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a screen configured to change between a first reflective state and a second reflective state having lower reflectivity; and
a light source configured to operate in a first brightness state when the screen operates in the first reflective state and to operate in a second brightness state having greater brightness when the screen operates in the second reflective state.

2. The apparatus of claim 1, wherein the screen and the light source are configured to change at a frequency greater than or equal to a flicker fusion frequency of an observer.

3. The apparatus of claim 1 further comprising a projector configured to change between a first projection state in which a first intensity of light is projected during the first reflective state of the screen and a second projection state in which a second lesser intensity of light is projected during the second reflective state of the screen.

4. The apparatus of claim 3, wherein the projector includes a light source, wherein the light source is overdriven during the first projection state.

5. The apparatus of claim 3, wherein changing of the projector is synchronized with the changing of the light source.

6. The apparatus of claim 3, wherein the projector includes a projection light source and wherein the projection light source is off during the second projection state.

7. The apparatus of claim 1, wherein electrical power is supplied to the light source from an electrical outlet at a frequency and wherein the screen is configured to change between the first reflective state and the second reflective state based upon the frequency.

8. The apparatus of claim 7, wherein the electrical power is an alternating current power source and wherein the apparatus further comprises circuitry configured to condition, a current provided by the alternating current power source, modify a voltage of the alternating current power source, trim a duty cycle of the modified voltage and to transmit the modified and trimmed voltage to the light source.

9. The apparatus of claim 1, wherein AC voltage is supplied to the light source and to the screen, wherein the light source and the screen each change in synchronization based upon a polarity of the AC voltage without direct communication between the light source and the screen.

10. The apparatus of claim 1, wherein the light source and the screen can communicate.

11. The apparatus of claim 1, wherein the screen is in the first reflective state at least 20 percent of time, wherein the light source has the second brightness less than 80 percent of time.

12. The apparatus of claim 1, wherein the light source comprises at least one light emitting device and at least one light transmission modulator.

13. The apparatus of claim 1, wherein the light source comprises:
an elongate arrangement of light emitting diodes; and
a support coupled to the light emitting diodes and including axially extending pins for charging and grounding the light emitting diodes, wherein the light emitting diode device is configured to emit light at a frequency greater than or equal to a flicker fusion frequency of an observer and with a work duty cycle of less than 80 percent.

14. The apparatus of claim 1, wherein the light source comprises:
a gas discharge light cell including short persistence phosphors; and
a support coupled to the gas discharge light cell and including axially extending pins configured to start, charge and ground the gas discharge light cell.

15. An apparatus comprising:
a light transmission modulator configured to be positioned between a source of light and a screen, wherein the light transmission modulator modulates between a first transmissive state and a second greater transmissive state at a rate greater than or equal to a flicker fusion frequency of an observer.

16. An apparatus comprising:
a screen configured to change between a first reflective state and a second lesser reflective state at a frequency greater than or equal to a flicker fusion frequency of an observer.

17. The apparatus of claim 16, wherein the screen is configured to be in the first reflective state at least 20 percent of time.

18. The apparatus of claim 16, wherein electrical power is supplied to the screen from an electrical outlet at a frequency and wherein the screen is configured to change between the first reflective state and the second reflective state based upon the frequency.

19. The apparatus of claim 16, wherein an alternating voltage is supplied to the screen and wherein the screen is configured to change based upon a polarity of the voltage.

20. A method comprising:
changing a screen between a first reflective state and a second lesser reflective state; and
changing a light source between a first brightness state, occurring during the first reflective state, and a second greater brightness state, occurring during the second reflective state.

21. The method of claim 20, wherein the changing of the screen and the light source occurs at a frequency greater than or equal to a flicker fusion frequency of observers.

22. The method of claim 20, wherein the screen receives AC voltage at a frequency from an electrical outlet and wherein the screen is changed between the first reflective state and the second reflective state based upon the frequency.

23. The method of claim 22, wherein the light source receives AC voltage at the frequency from an electrical outlet and wherein the light source is changed between the first brightness state and the second brightness state based upon the frequency.

24. The method of claim 20, wherein the light source receives AC voltage at the frequency from an electrical outlet and wherein the light source is changed between the first brightness state and the second brightness state based upon the frequency.

25. The method of claim 20 further comprising projecting light upon the screen with a projector, wherein the projector includes a color wheel having color filter segments separated by spokes and wherein the light source is changed so as to be in the second brightness state during interruption by the spokes of projected light.

26. The method of claim 20 further comprising projecting light upon the screen with a projector, wherein the projector includes a color wheel having color filter segments separated by physical or virtual spokes and wherein the screen is changed so as to be in the second reflective state during interruption by the spokes of projected light.

27. The method of claim 20 further comprising:
projecting light upon the screen with a projector; and
operating the projector in a first projection state in which a first intensity of light is projected, when the screen operates in the first reflective state and operating the projector in a second projection state, in which a second lesser intensity of light is projected, when the screen operates in the second lesser reflective state.

28. The method of claim 20, wherein changing the light source comprises changing a window between the first brightness state in which the window has a first translucency and the second greater brightness state in which the window has a second greater translucency.

29. An apparatus comprising:
a window device configured to change between a first translucency and a second greater translucency at a frequency greater than or equal to a flicker fusion frequency of an observer.

30. The apparatus of claim 29, wherein the window device is configured to receive an AC voltage at a frequency from an electrical outlet and wherein the window device changes between the first translucency and the second translucency based upon the frequency.

31. A computer readable medium comprising:
instructions to change a screen between a first reflective state and a second lesser reflective state; and
instructions to change a light source between a first brightness state, occurring during the first reflective state, and a second greater brightness state, occurring during the second reflective state.
